(19) United States
(12) Patent Application Publication
(10) Pub. No.: US 2015/0109959 A1
(43) Pub. Date: Apr. 23, 2015

(54) TRANSMISSION PATH MANAGEMENT SYSTEM AND METHOD

(71) Applicant: POWER-ALL NETWORKS LIMITED, Shatin (HK)

(72) Inventors: KAI ZHOU, Wuhan (CN); HAI-TAO LI, Wuhan (CN); MAO-HUA HE, Wuhan (CN)

(21) Appl. No.: 14/511,894

(22) Filed: Oct. 10, 2014

(30) Foreign Application Priority Data
Oct. 18, 2013 (CN) 201310490012.2

(51) Int. Cl. H04L 12/24; H04L 12/713

(52) U.S. Cl. CPC H04L 41/5051; H04L 41/20; H04L 41/0896; H04L 45/586
USPC 370/254

(57) ABSTRACT

A transmission path management method, configured to establish a virtual lease line (VLL), the method includes: assigning configuration information to ports to be connected according to VLL information including each router device determined as transmission nodes of the VLL and the ports to be connected, the configuration information comprising a VLL identifier code; labeling the ports used to connect of each router device by using the VLL identifier; and connecting the ports labeled the VLL identifier one by one to establish the VLL.

### CROSS-REFERENCE TO RELATED APPLICATIONS

This application claims priority to Chinese Patent Application No. 201310490012.2 filed on Oct. 18, 2013, the contents of which are incorporated by reference herein. This application is related to the following co-pending, commonly assigned patent applications, the disclosures of which are incorporated herein by reference in their entirety:

1. “NETWORK SYSTEM CAPABLE OF ENHANCING CONNECTION PERFORMANCE” by Zhou et al., whose Attorney Docket No is US53458.

2. “TRANSMISSION PATH CONTROL DEVICE” by Zhou et al., whose Attorney Docket No is US53454.

3. “TRANSMISSION PATH MANAGEMENT SYSTEM AND METHOD” by Zhou et al., whose Attorney Docket No is US53457.

4. “TRANSMISSION PATH CONTROL SYSTEM” by Zhou et al., whose Attorney Docket No is US53443.

5. “TRANSMISSION PATH MANAGEMENT DEVICE” by Zhou et al., whose Attorney Docket No is US53453.

6. “ON-DEMAND TRANSMISSION PATH PROVIDING SYSTEM AND METHOD D” by Zhou et al., whose Attorney Docket No is US53455.

### FIELD

The present disclosure relates to management systems, and particularly to a transmission path management system, and a method thereof.

### BACKGROUND

Nowadays, people located far apart can communicate with each other via a transmission path randomly generated in networks. However, the random generation of the transmission path in the network can be complex and may cause a long delay time.

### BRIEF DESCRIPTION OF THE DRAWINGS

Implementations of the present technology will now be described, by way of example only, with reference to the attached figures.

FIG. 1 is a block diagram of a transmission path management system.

FIG. 2 is a diagrammatic view of a management server connected to a number of local network devices.

FIG. 3 is a diagrammatic view of an user interface.

FIG. 4 is a diagrammatic view of a connection relationship of router devices constituting a transmission path.

FIG. 5 is a flowchart diagram of an embodiment of a path calculating method of a transmission path management method.

FIG. 6 is a flowchart diagram of an embodiment of a path establishing method of a transmission path management method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented. The term “module” refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like. The connection can be such that the objects are permanently connected or releasably connected.

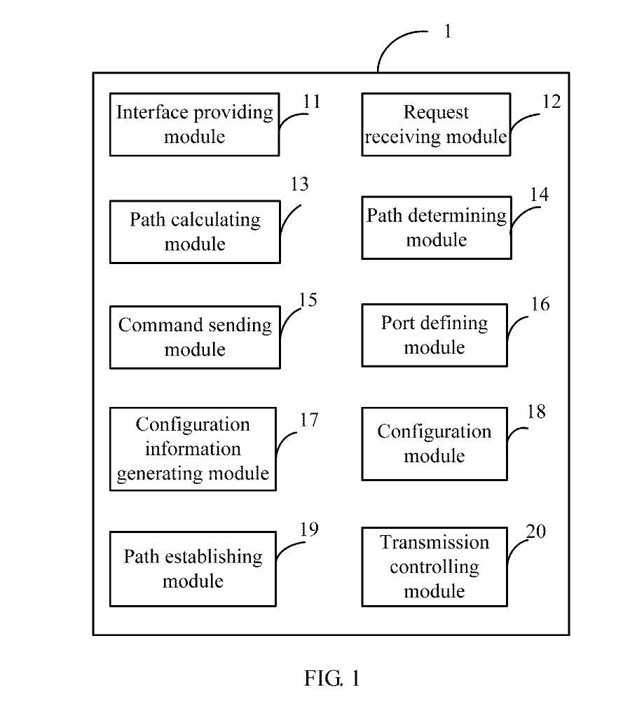

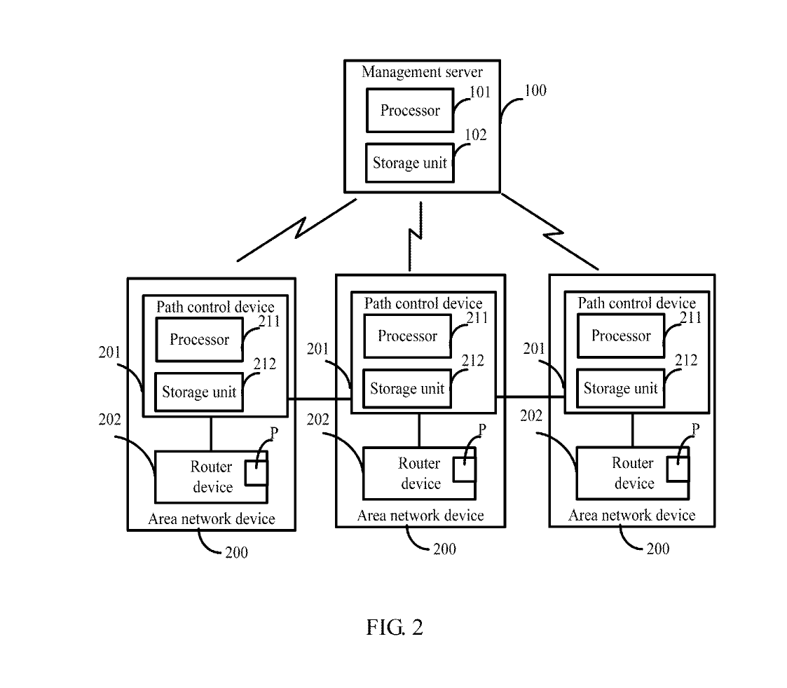

Referring to FIG. 1 and FIG. 2, a transmission path management system 1 is illustrated. The transmission path management system 1 is run in at least one management server 100 and a number of local network devices 200. Each local network device 200 is located in a corresponding area, specially, located in a corresponding geographic area. For example, one local network device 200 is located in New York, another local network device 200 is located in Philadelphia. In the embodiment, each local network device 200 can be an Internet Data Center (IDC) constituted by a number of computing devices.

In the embodiment, each local network device 200 at least includes a path control device 201 and a router device 202 connected to the path control device 201. Hereinafter, for simplicity, the router device 202 connected to the path control device 201 is represented as the router device 202 corresponding to the path control device 201. Each router device 202 includes a number of ports P. The management server 100 communicates with the path control devices 201 via corresponding networks. Each two path control devices 201 are also communicated to each other via corresponding networks. For example, the network can be Internet, a wireless network including WIFI and BLUETOOTH, a telecommunication network including a general packet radio service (GPRS) network and a code division multiple access (CDMA) network, or a broadcasting network. The network between the management server 100 and the path control device 201 and the network between the each two path control devices 201 can be the same or the different.

The path control device 201 stores a port topology file of the corresponding router device 202 connected to the path control device 201. The port topology file includes definitions of the number of ports P of the corresponding router device 202. In the embodiment, the definitions of the number of ports P can include which area is directed by each port.

The management server 100 includes a processor 101 and a storage unit 102. The path control device 201 also includes a processor 211 and a storage unit 212. The port topology file is stored in the storage unit 212 of the path control device 201. The path control device 201 can be a computing device, such as a personal computer or a server. The router device 202 can be a router, a switch, or a gateway.

The transmission path management system 1 includes an interface providing module 11, a request receiving module 12, a path calculating module 13, a path determining module 14, a command sending module 15, a port defining module 16, a configuration information generating module 17, a configuration module 18, a path establishing module 19, and a transmission controlling module 20.

In the embodiment, the interface providing module 11, the request receiving module 12, and the path determining module 14 can be collections of software instructions stored in the storage unit 102 of the management server 100 and executed by the processor 101 of the management server 100. The path calculating module 13, the command sending module 15, and the port defining module 16 can be collections of software instructions stored in the storage unit 212 of the path control device 201 and executed by the processor 211 of the path control device 201. The configuration information generating module 17, the configuration module 18, the path establishing module 19, and the transmission controlling module 20 can be collections of software instructions stored in the storage unit 102 of the management server 100 or the storage unit 212 of the path control device 201 and executed by the processor 101 of the management server 100 or the processor 211 of the path control device 201. The modules of the gateway configuration management system 1 also can include functionality represented as hardware or integrated circuits, or as software and hardware combinations, such as a special-purpose processor or a general-purpose processor with special-purpose firmware.

In another embodiment, the all of modules of the transmission path management system 1 can be collections of software instructions stored in the storage unit 102 of the management server 100 and executed by the processor 101 of the management server 100.

In one embodiment, each one of the processors 101, 211, can be a central processing unit, a digital signal processor, or a single chip, for example. In one embodiment, each one of the storage units 102, 212 can be an internal storage system, such as a flash memory, a random access memory (RAM) for temporary storage of information, and/or a read-only memory (ROM) for permanent storage of information. Each one of the storage units 102, 212 can also be a storage system, such as a hard disk, a storage card, or a data storage medium. Each one of the storage units 102, 212 can include volatile and/or non-volatile storage devices. In at least one embodiment, each one of the storage units 102, 212 can include two or more storage devices such that one storage device is a memory and the other storage device is a hard drive. Additionally, one or more of the storage units 102, 212 can be respectively located either entirely or partially external relative to the management server 100, and the path control device 201.

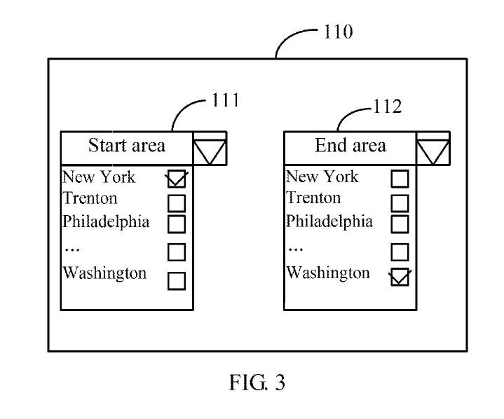

Referring also to FIG. 3, the interface providing module 11 is used to provide a user interface 110 provided for a user to input a start area and an end area of a virtual lease line (VLL). In detail, the user interface 110 at least includes a start input box 111 and an end input box 112. The start input box 111 is provided to input or select the start area of the VLL, and the end input box 112 is provided to input or select the end area of the VLL. The interface providing module 11 can provide the user interface 110 when the user logs in the user interface 110 successfully. As shown in FIG. 3, the start input box 111 and the end input box 112 are drop-down list boxes, and can provide a list including a number areas in response to user operations. In another embodiment, the start input box 111 or the end input box 112 also can be provided to input the start area or the end area directly.

The request receiving module 12 is used to receive a VLL establishing request provided by an operation on the user interface 110 by the user. In detail, the operation on the user interface 110 by the user can be that the user inputs or selects the start area and the end area respectively via the start input box 111 and the end input box 112. Therefore, when the user wants to establish the VLL, the user can input or select the start area and the end area of the VLL via the user interface 110 to produce the VLL establishing request. The VLL establishing request includes information of the start area and the end area of the VLL.

The path calculating module 13 is used to determine whether there is one port P of the router device 202 located in the start area is directed to the end area. If yes, namely, there is one port P of the router device 202 located in the start area is directed to the end area, the path calculating module 13 determines the router devices 202 located in the start area and the end area as transmission nodes constituting the VLL.

If not, namely there is no port P of the router device 202 located in the start area is directed to the end area, the path calculating module 13 determines a default router device 202 directed by the router device 202 located in the start area, and further determines whether there is one port P of the default router device 202 is directed to the end area. If yes, the path calculating module 13 determines the router devices 202 located in the start area, the default router device 202, and router device 202 located in the end area as the transmission nodes constituting the VLL.

If not, the path calculating module 13 further determines another default router device 202 directed by the default router device 202 whose ports are not directed to the end area, and further determines whether there is one port P of the another default router device 202 is directed to the end area.

Therefore, the path calculating module 13 executes the above steps repeatedly until the path calculating module 13 determines one port P of one router device 202 is directed to the end area, thus to determine a transmission path starting from the router device 202 located in the start area to the router device 202 located in the end area and passing through or not passing through at least one default router device 202 as the VLL. Namely, the path calculating module 13 determines the router device 202 located in the start area, the router device 202 located in the end area as the transmission nodes constituting the VLL, or determines the router device 202 located in the start area, the at least one default router device 202, and the router device 202 located in the end area as the transmission nodes constituting the VLL.

The path determining module 14 is used to determine which ports P of each router device 202 determined as the transmission nodes of the VLL are ports P to be connected to another port P of another router devices 202 also determined as the transmission node of the VLL, and generate VLL information including the router devices 202 determined as the transmission nodes of the VLL and the ports P to be connected. The path determining module 14 further determines the transmission path constituted by connecting the ports P to be connected one by one as the VLL.

In the embodiment, each router device 202 can connect to a corresponding default router device 202 via a predefined default port P. The path determining module 14 determines the default ports P used to connect to the default router device 202 and the port P directed to the end area of the router devices 202. Therefore, the determined ports P are the ports to be connected.

In detail, as described above, each area network device 200 is located in one corresponding area and corresponds to the area, therefore, the path control device 201 and the router device 202 included in each area network device 200 are also located in one corresponding area and correspond to the area. The path calculating module 13 determines the router device 202 located in the start area and the router device 202 located in the end area according to the start area and the end area included in the VLL establishing request.

The command sending module 15 is used to send the VLL establishing request to the path control device 201 located in the start area when the request receiving module 12 receives the VLL establishing request.

In more detail, when the path control device 201 receives the VLL establishing request, the path calculating module 13 determines whether one port P of the router device 202 corresponding to the path control device 201 located in the start area is directed to end area. If yes, the path calculating module 13 determines the router devices 202 located in the start area and the end area are the transmission nodes constituting the VLL.

If not, namely, if the path calculating module 13 determines no port P of the router device 202 corresponding to the path control device 201 located in the start area is directed to the end area, the command sending module 15 sends the VLL establishing request to a default path control device 201 that is connected to the current path control device 201 located in the start area by default.

As the same, the path calculating module 13 determines whether one port P of the router device 202 corresponding to the default path control device 201 currently receiving the VLL establishing request is directed to the end area. If yes, the path calculating module 13 determines the router device 202 located in the start area, the router device 202 corresponding to the default path control device 201, and the router device 202 located in the end area as the transmission nodes constituting the VLL.

If not, the command sending module 15 sends the VLL establishing request to another default path control device 201 that is connected to the current default path control device 201. The path calculating module 13 determines whether one port P of the router device 202 corresponding to the another default path control device 201 currently receiving the VLL establishing request is directed to the end area.

Therefore, the path calculating module 13 and the command sending module 15 executes the above steps repeatedly, until one port P of one router device 202 is directed to the end area.

As described above, each area network device 200 is set in one corresponding area. The storage unit 102 of the management server 100 further stores relationships between different areas and network addresses of the path control device 201 and the router device 202 of the different area network device 200. The command sending module 15 determines the network address of the path control device 201 according to the relationships, and sends the VLL establishing request to the path control device 201 according to the network address of the path control device 201. In detail, the command sending module 15 determines which path control device 201 needs to receive the VLL establishing request, and determines the area that the path control device 201 needs to receive the VLL establishing request located in. The command sending module 15 then determines the network address of the path control device 201 needs to receive the VLL establishing request according to the relationships stored in the storage unit 102, and sends the VLL establishing request to the path control device 201 according to the network address of the path control device 201. For example, if the path control device 201 needs to receive the VLL establishing request is the path control device 201 located in the start area, the command sending module 15 then determines the network address corresponding to the start area, and then sends the VLL establishing request to the path control device 201 according to the network address of the path control device 201.

The network addresses of the path control device 201 and the router device 202 can be Internet protocol (IP) addresses.

In the embodiment, each default path control device 201 is located in the corresponding area, and the router device 202 connected to the default path control device 201 is the default router device 202. Each path control device 201 can connect to a corresponding default path control device 201 by predefined.

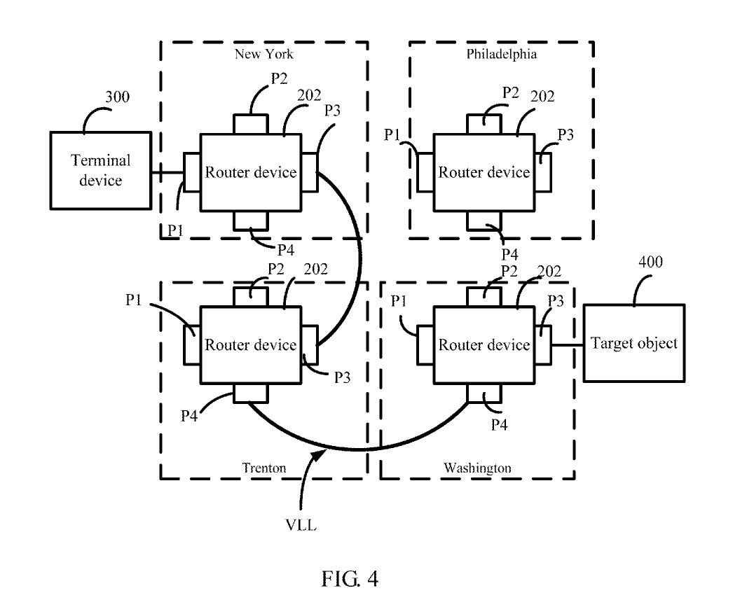

Referring also to FIG. 4, in detail, each router device 202 includes four ports P1˜P4, and an amount of the area network device 200 is four. The four area network devices 200 are respectively located in New York, Trenton, Philadelphia, and Washington. Assuming the start area is New York, and the end area is Washington.

As shown in FIG. 3, if the user selects or inputs the start area as New York, and selects or inputs the end area as Washington via the user interface 110, the command sending module 15 sends the VLL establishing request to the path control device 201 located in New York. The path calculating module 13 determines whether one port P of the router device 202 located in New York is directed to Washington. If yes, the path calculating module 13 determines the router device 202 located in New York and the router device 202 located in Washington as the transmission nodes constituting the VLL. If not, the path calculating module 13 sends the VLL establishing request to the default path control device 201 connected to the router device 202 located in New York by default. For example, assuming the default router device 202 is the router device 202 located in Trenton, then the path calculating module 13 sends the VLL establishing request to the path control device 201 located in Trenton.

The path calculating module 13 further determines whether one port P of the router device 202 located in Trenton is directed to Washington when the path control device 201 located in Trenton receives the VLL establishing request. If yes, the path calculating module 13 determines the router device 202 located in New York, the router device 202 located in Trenton, and the router device 202 located in Washington as the transmission nodes constituting the VLL.

As described above, the path determining module 14 generates the VLL information including the router devices 202 constituting the VLL and the ports P to be connected. Thus the transmission path constituted by connecting the ports to be connected of these router devices 202 constituting the VLL one by one is the VLL.

In more detail, as shown in FIG. 4, the path determining module 14 determines the transmission path constituted by connecting the port P1 of the router device 202 located in New York, the port P3 of the router device 202 located in New York, the port P2 of the router device 202 located in Trenton, the port P3 of the router device 202 located in Trenton, the port P4 of the router device 202 located in Washington, and the port P3 of the router device 202 located in Washington in sequence as the VLL. Namely, the VLL is the transmission path as followed: New York P1->New York P3->Trenton P2->Trenton P3->Washington P4->Washington P3.

The port defining module 16 is used to predefine the definitions the ports P of each router device 202. In detail, the port defining module 16 predefines the area directed by each port P of each router device 202 in response to operations of the Administer providing the VLL. Thus to generate the port topology file of each router device 202. The port defining module 16 further can predefine the default port directed to the default router device for each router device 202.

The configuration information generating module 17 is used to determine the ports P to be connected according to the VLL information, and assign configuration information to ports P to be connected. In the embodiment, the configuration information includes a VLL identifier code. In the embodiment, the VLL identifier code is corresponding to an identity of the user requests to establish the VLL. The identity of the user can be a user name which the user used to log in the user interface 110, or an identity card number of the user.

The configuration module 18 is used to label the ports P to be connected of each router device 202 by using the VLL identifier code. Namely, the configuration module 18 adds the VLL identifier code to the ports P to be connected.

The path establishing module 19 is used to connect the port P labeled the VLL identifier code one by one according to port connection information of each port P to be connected, thus to establish the VLL. In the embodiment, the path establishing module 19 determines which ports P that the each port P to be connected is needed to connect according to the positions of the router devices 202 constituting the VLL, thus to obtain the port connection information for each port P. Namely, the port connection information for each port P includes the information of to which ports P that the each port P connects.

As shown in FIG. 4, the path establishing module 19 further establishes a connection between the router device located in the start area and the terminal device 300 of the user generating the VLL establishing request. The path establishing module 19 further establishes a connection between the router device located in the end area and a target object 400. Therefore, the terminal device 300 is connected to the target object 400 via the VLL. In detail, the path establishing module 19 connects one of the ports P of the router device 202 located in the start area to the terminal device 300, and connects one of the ports P of the router device 202 located in the end area to the target object 400, thus to establish the connection between the terminal device 300 and the target object via the VLL.

In the embodiment, the target object 400 can be another terminal device 300 or a network, such as a private network, Internet, for example. When the target object 400 is the terminal device 300, the path establishing module 19 connects one of the ports P of the router device 202 located in the end area to the target object 400. When the target object 400 is the network, the path establishing module 19 connects one of the ports P of the router device 202 located in the end area to the target object 400.

In another embodiment, the user interface 110 also provide a bandwidth input box (not shown) and a time input box (not shown). The bandwidth input box is provided to input the bandwidth of the requested VLL, and the time input box is provided to input a start time and an end time of the requested VLL. The configuration information assigned by the configuration information generating module 17 further includes information of the bandwidth and the start time, the end time input by the user. The path establishing module 19 controls to establish the VLL with the corresponding bandwidth during the start time and the end time.

The transmission controlling module 20 is used to label data transmitted by the user by using the VLL identifier code, and control the data to transmit via the ports P labeled the same VLL identifier code when transmitting the data via the router device 202 constituting the VLL. In the embodiment, when one user starts to transmit the data, the transmission controlling module 20 obtains the identity of the user and determines the VLL identifier code corresponding to the identity of the user, and then labels the data to be transmitted by using the VLL identifier code.

As shown in FIG. 4, the user can connect to the router device 202 located in the start area via the terminal device 300, and the router device 202 located in the end area is connected to the target object 400. Therefore, the user can access the target object 400 via the VLL constituted by the corresponding router devices 202.

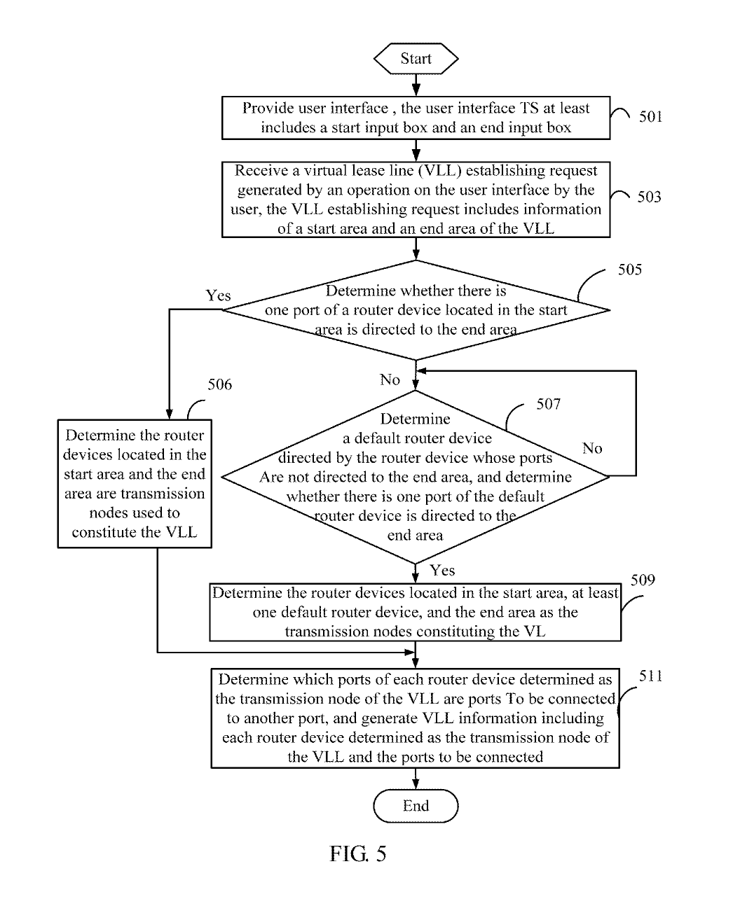

FIG. 5 illustrates a flowchart of a transmission path calculating method of a transmission path management method. The method is provided by way of example, as there are a variety of ways to carry out the method. The method described below can be carried out using the configurations illustrated in FIG. 2, for example, and various elements of these figures are referenced in explaining the example method. Each block shown in FIG. 5 represents one or more processes, methods, or subroutines carried out in the example method. Additionally, the illustrated order of blocks is by example only and the order of the blocks can be changed. The example method can begin at block 501.

In block 501, an interface providing module provides a user interface, the user interface at least includes a start input box and an end input box.

In block 503, a request receiving module receives a VLL establishing request generated by an operation on the user interface by the user, the VLL establishing request includes information of a start area and an end area of the VLL. In detail, the operation on the user interface by the user can be the user inputs or selects the start area and the end area respectively via the start input box and the end input box.

In block 505, a path calculating module determines whether there is one port of a router device located in the start area is directed to the end area. If yes, the process jumps to block 506, if not, the process jumps to block 507. In detail, a command sending module sends the VLL establishing request to a path control device located in the start area when the request receiving module receives the VLL establishing request, the path calculating module determines whether one port of the router device located in the start area is directed to end area according to the information of the start area and the end area of the VLL included in VLL establishing request.

In block 506, the path calculating module determines the router devices located in the start area and the end area are transmission nodes constituting the VLL.

In block 507, the path calculating module determines a default router device directed by the router device whose ports are not directed to the end area, and further determines whether there is one port of the default router device is directed to the end area. If not, the process returns to block 507, if yes, the process jumps to block 509. In detail, the command sending module sends the VLL establishing request to a default path control device that connected to the current path control device by default, the path calculating module determines whether one port P of the router device corresponding to the path control device currently receiving the VLL establishing request is directed to end area.

In block 509, the path calculating module determines the router devices located in the start area, at least one default router device, and the end area as the transmission nodes constituting the VLL.

In block 511, a path determining module determines which ports of each router device determined as the transmission node of the VLL are ports to be connected to another port, and generates VLL information including the router devices determined as the transmission node of the VLL and the ports to be connected of each router device. The ports to be connected are those ports of each router device determined as the transmission node of the VLL to be connected to another port of another router device determined as the transmission node of the VLL.

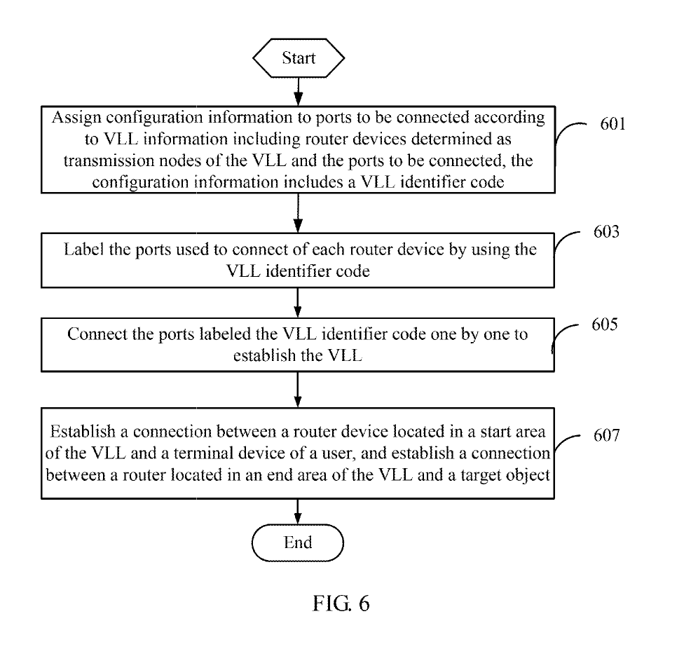

FIG. 6 illustrates a flowchart of a transmission path establishing method of the transmission path management method. The method is provided by way of example, as there are a variety of ways to carry out the method. The method described below can be carried out using the configurations illustrated in FIG. 2, for example, and various elements of these figures are referenced in explaining the example method. Each block shown in FIG. 6 represents one or more processes, methods, or subroutines carried out in the example method. Additionally, the illustrated order of blocks is by example only and the order of the blocks can be changed. The example method can begin at block 601.

In block 601, a configuration information generating module assigns configuration information to ports to be connected according to VLL information including each router device determined as transmission nodes of the VLL and the ports to be connected, the configuration information comprising a VLL identifier code.

In block 603, a configuration module labels the ports to be connected of each router device by using the VLL identifier code

In block 605, a path establishing module connects the port P labeled the VLL identifier code one by one, thus to establish the VLL.

In block 607, the path establishing module establishes a connection between the router device located in the start area and the terminal device of the user generating the establishing request, and establishes a connection between the router device located in the end area and a target object, thus to establish a connection between the terminal device and the target object via the VLL.

In the embodiment, the transmission path establishing method further includes: a transmission controlling module labels data transmitted by the user by using the VLL identifier code, and controls the data to transmit via the ports labeled the same VLL identifier code when transmitting the data via the router device constituting the VLL.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A transmission path management system, configured to establish a virtual lease line (VLL), the system comprising:
at least one processor; and
a plurality of modules which are collections of instructions executed by the processor, the plurality of modules comprising:
a configuration information generating module configured to assign configuration information to ports to be connected according to VLL information, wherein the VLL information comprises router devices determined as transmission nodes of the VLL and the ports to be connected, the configuration information comprising a VLL identifier code, the ports to be connected are ports of the router devices determined as the transmission nodes of the VLL used to connect to another port of other router devices also determined as the transmission nodes of the VLL;
a configuration module configured to label the ports to be connected by using the VLL identifier code; and
a path establishing module configured to connect the ports labeled the VLL identifier code one by one to establish the VLL.

2. The system according to claim 1, wherein the path establishing module is further configured to establish a connection between a first router device located in a start area of the VLL and a terminal device of a user, and to establish a connection between a second router device located in an end area of the VLL and a target object.

3. The system according to claim 2, wherein the modules further comprise a transmission controlling module configured to label data transmitted from the terminal device of the user by using the VLL identifier code, and control the data to transmit via the ports labeled the same VLL identifier code.

4. The system according to claim 2, wherein the target object comprises one of a group consisting of a private network, an Internet, a terminal device located in the end area of the VLL.

5. The system according to claim 2, wherein the configuration information further comprises information of a bandwidth, a start time, an end time of the VLL, the path establishing module controls to establish the VLL with the corresponding bandwidth during the start time and the end time.

6. A transmission path management method, configured to establish a virtual lease line (VLL), the method comprising:
assigning configuration information to ports to be connected according to VLL information, wherein the VLL information comprises router devices determined as transmission nodes of the VLL and the ports to be connected, the configuration information comprising a VLL identifier code, the ports to be connected are ports of the router devices determined as the transmission nodes of the VLL used to connect to another port of other router devices determined as the transmission nodes of the VLL;
labeling the ports to be connected of each router device by using the VLL identifier; and
connecting the ports labeled the VLL identifier one by one to establish the VLL.

7. The method according to claim 6, further comprising:
establishing a connection between a first router device located in a start area of the VLL and a terminal device of a user; and
establishing a connection between a second router device located in an end area of the VLL and a target object.

8. The method according to claim 7, further comprising:
labeling data transmitted by the user by using the VLL identifier; and
controlling the data to transmit via the ports labeled the same VLL identifier.

9. The method according to claim 7, wherein the configuration information further comprises information of the bandwidth and a start time an end time of the VLL, the step of connecting the ports labeled the VLL identifier one by one to establish the VLL comprising:
connecting the ports labeled the VLL identifier one by one to establish the VLL with the corresponding bandwidth during the start time and the end time.

10. The method according to claim 7, wherein the target object comprises one of a group consisting of a private network, an Internet, a terminal device located in the end area of the VLL.

11. A non-transitory storage medium having stored thereon instructions that, when executed by at least one processor of a computing device, causes the least one processor to execute instructions of a method for automatically establishing a virtual lease line (VLL), the method comprising:
assigning configuration information to ports to be connected to another port of router devices determined as transmission nodes of the VLL according to VLL information comprising each router device determined as transmission nodes of the VLL and the ports to be connected, the configuration information comprising a VLL identifier code;
labeling the ports to be connected of each router device by using the VLL identifier; and
connecting the ports labeled the VLL identifier one by one to establish the VLL.

12. The non-transitory storage medium according to claim 11, wherein the method further comprising:
establishing a connection between a first router device located in a start area of the VLL and a terminal device of a user; and
establishing a connection between a second router device located in an end area of the VLL and a target source.

13. The non-transitory storage medium according to claim 12, wherein the method comprising:
labeling data transmitted by the user by using the VLL identifier; and
controlling the data to transmit via the ports labeled the same VLL identifier.

14. The non-transitory storage medium according to claim 11, wherein the configuration information further comprises information of the bandwidth and a start time and an end time of the VLL, the step of connecting the ports labeled the VLL identifier one by one to establish the VLL comprising:
connecting the ports labeled the VLL identifier one by one to establish the VLL with the corresponding bandwidth during the start time and the end time.
